(19) United States
(12) Patent Application Publication
(10) Pub. No.: US 2025/0138726 A1
(43) Pub. Date: May 1, 2025

(54) An Arrangement and a Method for Providing Text Input in Virtual Reality

(71) Applicant: Telefonaktiebolaget LM Ericsson (publ), Stockholm (SE)

(72) Inventors: Fredrik Dahlgren, Lund (SE); Andreas Kristensson, Södra Sandby (SE); Alexander Hunt, Tygelsjö (SE)

(21) Appl. No.: 18/683,979

(22) PCT Filed: Aug. 18, 2021
(86) PCT No.: PCT/EP2021/072952

§ 371 Date: Feb. 15, 2024

(51) Int. Cl. G06F 3/04886; G06F 3/01

(52) U.S. Cl. CPC G06F 3/04886; G06F 3/014; G06F 3/016; G06F 2203/04803

(57) ABSTRACT

A virtual object presenting arrangement (100) for providing text input comprising an image presenting device (110) arranged to display virtual keyboard (230) comprising one or more virtual keys (231), wherein the one or more keys (231) are arranged so that a movement over a distance for a finger is required to move from one key (231) to a next key (231), the virtual object presenting arrangement (100) comprising a controller (101) configured to determine a predicted next key (231) in the virtual keyboard (230) and to reduce the distance required to move to the predicted next key (231).

### TECHNICAL FIELD

The present invention relates to an arrangement, an arrangement comprising computer software modules, an arrangement comprising circuits, a device and a method for providing text input in virtual reality, and in particular to an arrangement, an arrangement comprising computer software modules, an arrangement comprising circuits, a device and a method for providing text input in virtual reality through a virtual reality keyboard.

### BACKGROUND

Virtual reality (VR) refers to a computer-generated simulation in which a person can interact within an artificial three-dimensional environment using electronic devices, such as special goggles with a screen or gloves fitted with sensors.

Augmented (extended or mixed) reality (AR) is an interactive experience of a real-world environment where the objects that reside in the real world are enhanced by computer-generated perceptual information.

In VR systems, the user is not really looking at the real world, but a captured and presented version of the real world. In a VR system, the world experienced may be completely made up.

In AR systems the world experienced is a version of the real world overlaid with virtual objects, especially when the user is wearing a head-mounted device (HMD) such as AR goggles. The real world version may be a captured version such as when using a smartphone where the camera captures the real world and presents it on the display—overlaid with virtual objects. The real world may in some systems be viewed directly, such as when using AR goggles or other Optical See Through systems, where the user is watching the real world directly but with overlaid virtual objects.

As a user in VR system (or even some AR systems) is not able to see any of the real world objects directly there is a problem in how to provide text input capabilities to the user in an efficient manner and in existing VR solutions today, text input is typically quite cumbersome.

There are several solutions available: using a finger or hand-controller as a pen and draw in either 3D-space or on a plane which is shown in VR space (the latter can be a whiteboard), or by getting a virtual keyboard up in front of the user and use hand-controller or a finger to type on it. When using finger, there are typically a forward-facing camera that detect hand gestures, and which also estimates the position of the hand in the room in 3 dimensions in order to determine when the user actually hits a key on the virtual keyboard. When using a hand-controller, that said controller includes sensors such as IMU which greatly simplifies the estimation on where in 3D-space the hand is pointing.

There are prior art solutions where a physical keyboard is recognized by the system (for example by the system's camera) so it is visible in the VR world, the position of the hands can either be recognized by the camera or by letting the virtual office area be transparent or semitransparent meaning that the VR user actually sees the real physical hands and keyboards. This allows the user to more efficiently access a real physical keyboard also in VR space in order to type faster.

There are several proposals for haptic gloves with exoskeleton structures or similar methods capable of making force on finger movements and detect the bending and relative movements of fingers.

As the inventors have realized, there is thus a need for a device and a method for providing a text input in a VR system.

### SUMMARY

As the inventors have realized, the main problem with today's state-of-practice, using fingers or hand-controller to hand-write on a whiteboard, virtual paper, or in 3D-space is not an efficient way to create longer texts such as reports, searching on internet, summary of discussion, or similar. Furthermore, the inventors have also realized that to use hands or fingers which are recognized by cameras to type text on a virtual-plane keyboard must overcompensate for inaccuracies by the 3D-position estimation, meaning that gestures are typically large and there is no haptic feedback when typing resulting in very low typing speed, non-ergonomical arm and hand movements, and a high likelihood for wrong input. Using hand-controllers with integrating IMUs help making estimated 3D-position much better, and there is an opportunity for integrating a haptic feedback (e.g. vibration) at virtual key-press, but to move the hands/arms onto a virtual plane is still difficult from an accuracy perspective meaning that arm and hand movements are overcompensated to secure that a keypress is recognized and there is no involuntary key-press leading to very slot typing and non-ergonomical movements. Overall, this is not very useful for writing text at reasonable speed or length.

The keyboard which is recognized by VR environment is good for typing but the inventors have recognized a problem in that it severely limits the position of the user (must sit/stand at table) and has limitations in how it can be integrated into VR applications. Furthermore, whereas VR enables opportunities beyond physical limits, the inventors have realized that the physical keyboard is by definition limited to its physical shape, number and position of buttons, etc.

Exoskeleton-based or similar gloves are quite advanced, costly, and can be considered as overkill (especially as regards cost) for usage in many situations where the primary purpose is key-press and keyboard-type applications. Furthermore, they do not provide the means for efficiency of typing in VR space.

Voice input is possible, and there are several speech-to-text services available. However, these typically are based on cloud-based services from major IT-companies and confidential information should not be inserted with those services. Furthermore, these have still not been mainstream for computer usage, and there is no reason to expect that it would be the preferred approach in VR space either if a type-based approach becomes available at least on par with the typing opportunities for desktops and laptops. Finally, in VR space, a user may not be aware who else is standing nearby, which makes voice input a fundamentally flawed solution from a privacy perspective.

An object of the present teachings is to overcome or at least reduce or mitigate the problems discussed in the background section. Although the teachings herein will be directed at Virtual Reality, the teachings may also be applied to Augmented Reality systems. In order to differentiate from the two types of systems while discussing common features, the text input will be referred to as virtual text input, and be applicable to both VR systems and to AR systems.

According to one aspect a virtual object presenting arrangement comprising an image presenting device arranged to display a virtual environment and a controller configured to: detect a location of a hand; provide a virtual keyboard at the location of the hand, the virtual keyboard being nonlinearly mapped to the hand; detect a relative movement of the hand; select a virtual key based on the relative movement; and input a text character associated with the selected key in the virtual environment.

The solution may be implemented as a software solution, a hardware solution or a mix of software and hardware components.

In some embodiments the controller is further configured to detect the location of the hand by detecting a location of at least one finger and nonlinearly map the virtual keyboard to the hand by associating a set of virtual keys to each of the at least one finger.

In some embodiments the controller is further configured to nonlinearly map the virtual keyboard to the hand by aligning the virtual position of one virtual key in the associated set of virtual keys with the location of the associated finger.

In some embodiments the relative movement is relative to a start position.

In some embodiments the relative movement is relative to a maximum movement.

In some embodiments the relative movement is relative to a continued movement.

In some embodiments the relative movement is relative to a feedback.

In some embodiments the controller is further configured to provide tactile feedback (F) when crossing a delimiter (S).

In some embodiments the controller is further configured to provide tactile feedback (F) when being on a virtual key.

In some embodiments the controller is further configured to provide tactile feedback (F) when a keypress is detected.

In some embodiments the virtual object presenting arrangement further comprising a camera at least one sensor, wherein the controller of the virtual object presenting arrangement is configured to determine the location and to determine the relative movement of the hand by receiving image data from the camera.

According to one aspect a virtual object presenting system is provided, the virtual object presenting system comprises a virtual object presenting arrangement according to any of claims 14 to [symbol] and an accessory device, the virtual object presenting arrangement further comprising a sensor device and the accessory device comprising at least one sensor, wherein the controller of the virtual object presenting arrangement is configured to determine the location and to determine the relative movement of the hand by receiving sensor data from the at least one sensor of the accessory device through the sensor device.

In some embodiments the accessory device further comprising one or more actuators for providing tactile feedback, and wherein the controller of the virtual object presenting arrangement is configured to provide said tactile feedback through the at least one of the one or more actuators. In some embodiments the accessory device being a glove.

In some embodiments the virtual object presenting system comprises two accessory devices.

According to another aspect there is provided a method for a virtual object presenting arrangement comprising an image presenting device arranged to display a virtual environment, the method comprising: detecting a location of a hand; providing a virtual keyboard at the location of the hand, the virtual keyboard being nonlinearly mapped to the hand; detecting a relative movement of the hand; selecting a virtual key based on the relative movement; and inputting a text character associated with the selected key in the virtual environment.

According to another aspect there is provided a computer-readable medium carrying computer instructions that when loaded into and executed by a controller of a virtual object presenting arrangement enables the virtual object presenting arrangement to implement the method according to herein.

According to another aspect there is provided a software component arrangement for adapting a user interface in a virtual object presenting arrangement, wherein the software component arrangement comprises a software module for detecting a location of a hand; a software module for providing a virtual keyboard at the location of the hand, the virtual keyboard being nonlinearly mapped to the hand; a software module for detecting a relative movement of the hand; a software module for selecting a virtual key based on the relative movement; and a software module for inputting a text character associated with the selected key in the virtual environment.

For the context of the teachings herein a software module may be replaced or supplemented by a software component.

According to another aspect there is provided an arrangement comprising circuitry for presenting virtual objects according to an embodiment of the teachings herein. The arrangement comprising circuitry for detecting a location of a hand; circuitry for providing a virtual keyboard at the location of the hand, the virtual keyboard being nonlinearly mapped to the hand; circuitry for detecting a relative movement of the hand; circuitry for selecting a virtual key based on the relative movement; and circuitry for inputting a text character associated with the selected key in the virtual environment.

The aspects provided herein are beneficial in that they mitigate or overcome the limitations of today's technologies relating to how to input text in a virtual environment.

The aspects provided herein are beneficial in that they enable for a user to not need to position the hands over a perfect plane (perfect alignment of physical hands above a virtual keyboard), since it is the relative movement of fingers and the distinct acceleration at key-presses that matter—this simplifies the implementation since no perfect 3D alignment of physical hands and fingers relative to a virtual plane and representation is necessary or required.

The aspects provided herein are beneficial in that they enable for a user to be able to write on a virtual keyboard in VR space as efficiently as on a real keyboard because of the tactile feedback.

The aspects provided herein are beneficial in that the definition of a fast tap of a finger-tip on a key means a keypress also simplifies typing since no involuntary touching of keys, leading to keypresses, can happen which is otherwise common with keyboard based on alignment between a finger/hand and a virtual plane.

According to a second aspect there is provided a method for providing text input in a virtual object presenting arrangement comprising an image presenting device arranged to display a virtual keyboard comprising one or more virtual keys, wherein the one or more keys are arranged so that a movement is required to move from one key to a next key, the method comprising determining a predicted next key in the virtual keyboard and reducing the movement required to move to the predicted next key.

In one embodiment the method further comprises providing tactile feedback indicating that the predicted next key is reached.

It should be noted that the feedback provided according to itself is in one aspect an invention on its own and embodiments discussed in relation to how feedback is provided may be separated from the embodiments in which they are discussed as it should be realized after reading the disclosure herein that the feedback may be provided regardless the keyboard used and regardless he further guiding provided.

According to an aspect there is provided a computer-readable medium carrying computer instructions that when loaded into and executed by a controller of a virtual object presenting arrangement enables the virtual object presenting arrangement to implement the method according to herein.

According to an aspect there is provided a software component arrangement for providing text input in a virtual object presenting arrangement comprising an image presenting device arranged to display a virtual keyboard comprising one or more virtual keys, wherein the one or more keys are arranged so that a movement is required to move from one key to a next key, wherein the software component arrangement comprises: a software component for determining a predicted next key in the virtual keyboard and a software component for reducing the movement required to move to the predicted next key.

According to an aspect there is provided a virtual object presenting arrangement for providing text input comprising an image presenting device arranged to display virtual keyboard comprising one or more virtual keys, wherein the one or more keys are arranged so that a movement is required to move from one key to a next key, the virtual object presenting arrangement comprising circuitry for determining a predicted next key in the virtual keyboard and circuitry for reducing the movement required to move to the predicted next key.

According to an aspect there is provided a virtual object presenting arrangement for providing text input comprising an image presenting device arranged to display virtual keyboard comprising one or more virtual keys, wherein the one or more keys are arranged so that a movement is required to move from one key to a next key, the virtual object presenting arrangement comprising a controller configured to determine a predicted next key in the virtual keyboard and to reduce the movement required to move to the predicted next key.

In one embodiment the controller is further configured to receive a selection of a present key and to determine the predicted next key based on the present key.

In one embodiment the controller is further configured to receive an input of text and to determine the predicted next key based on the input text.

In one embodiment the controller is further configured to reduce the distance of the movement required to move to the predicted next key by reducing a distance (S) to the predicted next key.

In one embodiment the controller is further configured to reduce the movement required to move to the predicted next key by receiving a movement of a user and to scale up the movement of the user in the direction of the predicted next key thereby reducing the distance required to move to the predicted next key.

In one embodiment the controller is further configured to reduce the movement required to move to the predicted next key by increasing a size of the predicted key thereby reducing the distance required to move to the predicted next key.

In one embodiment the controller is further configured to reduce the movement required to move to the predicted next key by increasing a size of the selected key thereby reducing the distance required to move to the predicted next key.

In one embodiment the controller is further configured to increase the size of the selected key in the direction of the predicted next key.

In one embodiment the controller is further configured to provide tactile feedback (F) when crossing a delimiter (S).

In one embodiment the controller is further configured to provide tactile feedback (F) when being on a virtual key.

In one embodiment the controller is further configured to provide tactile feedback (F) when a keypress is detected.

According to one aspect there is provided a virtual object presenting system comprising a virtual object presenting arrangement according to any of claims 33 to 35 and an accessory device, the accessory device comprising one or more actuators (215), wherein the controller of the virtual object presenting arrangement is configured to provide feedback through the one or more actuator (215).

In one embodiment the accessory device being a glove and at least one of the one or more actuators (215) is arranged at a finger tip of the glove.

As noted herein these aspects may be combined in one, some or all manners as discussed herein. The aspects discussed herein may also be seen on their own and utilized without any combination with another aspect. For example the system of one aspect may be the same as the system of another aspect.

The aspects provided herein are beneficial in that since the arms and the hands need not be physically positioned above an imaginary specified keyboard, they can be positioned in a more comfortable position (along the side of the user, resting on the arm-chair, or in a more ergonomically correct position), it is physically less burdensome for the user. Reduces risk for gorilla-arm syndrome. The aspects provided herein are beneficial in that feedback to user if position of arm is ergonomically good and efficient is provided.

The aspects provided herein are beneficial since any keyboard layout with uniquely added keys (application or user-specific) as well as many other input devices (mouse, joystick) can be represented, there are opportunities for an experience which goes way beyond the physical keyboard and mouse.

The aspects provided herein are beneficial in that the tactile feedback as fingers move across keyboard (the user “touches” the virtual keys, the likelihood of involuntary pressing in between keys is minimized, and it is possible to write without looking at keyboard.

The aspects provided herein are beneficial in that the snapping to keys (both visually and tactile) allows a more distinct feeling of finding keys when not looking at the keyboard, which can further reduce the risk of pressing in between keys leading to an ambiguity of which key is pressed.

Further embodiments and advantages of the present invention will be given in the detailed description. It should be noted that the teachings herein find use in smartphones, smartwatches, tablet computers, media devices, and even in vehicular displays.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1A shows a schematic view of a virtual object presenting arrangement according to an embodiment of the present invention;

FIG. 1B shows a schematic view of a virtual object presenting arrangement according to an embodiment of the present invention;

FIG. 1C shows a schematic view of a virtual object presenting arrangement according to an embodiment of the present invention;

FIG. 2A shows a schematic view of virtual object presenting arrangement system having a user interface according to some embodiments of the teachings herein;

FIG. 2B shows a schematic view of a part of the virtual object presenting arrangement system such as that of FIG. 2A according to some embodiments of the teachings herein;

FIG. 2C shows a schematic view of a part of the virtual object presenting arrangement system such as that of FIG. 2A according to some embodiments of the teachings herein;

FIG. 2D shows a schematic view of a part of the virtual object presenting arrangement system such as that of FIG. 2A according to some embodiments of the teachings herein;

FIG. 2E shows a schematic view of a part of the virtual object presenting arrangement system such as that of FIG. 2A according to some embodiments of the teachings herein;

FIG. 3A shows a flowchart of a general method according to an embodiment of the present invention;

FIG. 3B shows a flowchart of a general method according to an embodiment of the present invention;

FIG. 4A shows a schematic view of a part of the virtual object presenting arrangement system in an example situation according to some embodiments of the teachings herein;

FIG. 4B shows a schematic view of a part of a virtual object presenting arrangement system such as in a later instance of the example situation of FIG. 4A according to some embodiments of the teachings herein;

FIG. 4C shows a schematic view of a part of a virtual object presenting arrangement system such as in a later instance of the example situation of FIG. 4A according to some embodiments of the teachings herein;

FIG. 4D shows a schematic view of a part of a virtual object presenting arrangement system such as in a later instance of the example situation of FIG. 4A according to some embodiments of the teachings herein;

FIG. 4E shows a schematic view of a part of a virtual object presenting arrangement system such as in a later instance of the example situation of FIG. 4A according to some embodiments of the teachings herein;

FIG. 4F shows a schematic view of a part of a virtual object presenting arrangement system such as in a later instance of the example situation of FIG. 4A according to some embodiments of the teachings herein;

FIG. 4G shows a schematic view of a part of a virtual object presenting arrangement system such as in a later instance of the example situation of FIG. 4A according to some embodiments of the teachings herein;

FIG. 4H shows a schematic view of a part of a virtual object presenting arrangement system such as in a later instance of the example situation of FIG. 4A according to some embodiments of the teachings herein;

FIG. 4I shows a schematic view of a part of a virtual object presenting arrangement system such as in a later instance of the example situation of FIG. 4A according to some embodiments of the teachings herein;

FIG. 4J shows a schematic view of a part of a virtual object presenting arrangement system such as in a later instance of the example situation of FIG. 4A according to some embodiments of the teachings herein;

FIG. 4K shows a schematic view of a part of a virtual object presenting arrangement system such as in a later instance of the example situation of FIG. 4A according to some embodiments of the teachings herein;

FIG. 4L shows a schematic view of a part of a virtual object presenting arrangement system such as in a later instance of the example situation of FIG. 4A according to some embodiments of the teachings herein;

FIG. 5A shows a component view for a software component arrangement according to an embodiment of the teachings herein;

FIG. 5B shows a component view for a software component arrangement according to an embodiment of the teachings herein;

FIG. 6A shows a component view for an arrangement comprising circuits according to an embodiment of the teachings herein;

FIG. 6B shows a component view for an arrangement comprising circuits according to an embodiment of the teachings herein; and

FIG. 7 shows a schematic view of a computer-readable medium carrying computer instructions that when loaded into and executed by a controller of an arrangement enables the arrangement to implement an embodiment of the present invention.

### DETAILED DESCRIPTION

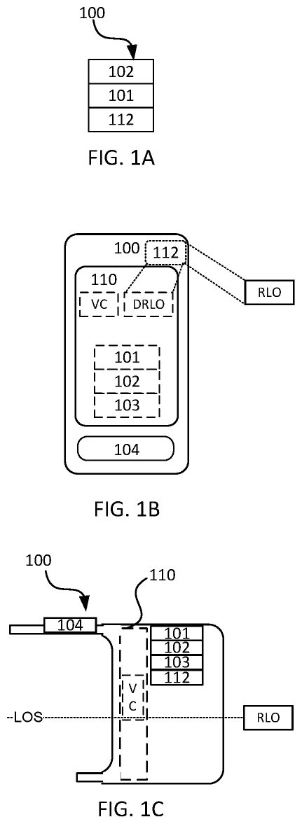

FIG. 1A shows a schematic view of a virtual display arrangement 100 according to an embodiment of the present invention. The virtual display arrangement 100 comprises or is operably connected to a controller 101 and a memory 102. The virtual display arrangement 100 also comprises an sensor device, comprising for example an image capturing device 112 (such as a camera or image sensor) capable of detecting an optical pattern through receiving light (for example visual, ultraviolet or infrared to mention a few examples), possibly in cooperation with the controller 101.

The sensor device 112 may be comprised in the virtual display arrangement 100 by being housed in a same housing as the virtual display arrangement, or by being operably connected to it, by a wired connection or wirelessly.

It should be noted that the virtual display arrangement 100 may comprise a single device or may be distributed across several devices and apparatuses. It should also be noted that the virtual display arrangement 100 may comprise a display device or it may be connected to a display device for displaying virtual content as will be discussed herein.

The controller 101 is also configured to control the overall operation of the virtual display arrangement 100. In some embodiments, the controller 101 is a graphics controller. In some embodiments, the controller 101 is a general-purpose controller. In some embodiments, the controller 101 is a combination of a graphics controller and a general-purpose controller. As a skilled person would understand there are many alternatives for how to implement a controller, such as using Field-Programmable Gate Arrays circuits, AISIC, GPU, etc. in addition or as an alternative. For the purpose of this application, all such possibilities and alternatives will be referred to simply as the controller 101.

The memory 102 is configured to store graphics data and computer-readable instructions that when loaded into the controller 101 indicates how the virtual display arrangement 100 is to be controlled. The memory 102 may comprise several memory units or devices, but they will be perceived as being part of the same overall memory 102. There may be one memory unit for a display arrangement storing graphics data, one memory unit for sensor device storing settings, one memory for the communications interface (see below) for storing settings, and so on. As a skilled person would understand there are many possibilities of how to select where data should be stored and a general memory 102 for the virtual display arrangement 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 102.

It should be noted that the teachings herein find use in virtual display arrangements in many areas of displaying content such as branding, marketing, merchandising, education, information, entertainment, gaming and so on.

FIG. 1B shows a schematic view of a virtual display arrangement 100 being a viewing device 100 according to an embodiment of the present invention. In this embodiment, the viewing device 100 is a smartphone or a tablet computer, being examples of VST devices. In such an embodiment, the viewing device further comprises a (physical) display arrangement 110, which may be a touch display, and the sensor device 112 may be a camera of the smartphone or tablet computer. In such an embodiment the controller 101 is configured to receive an image from the camera 112 and possibly display the image on the display arrangement 110 along with virtual content VC. In the example embodiment of FIG. 1B, the camera 112 is arranged on a backside (opposite side of the display 110, as is indicated by the dotted contour of the cameras 112) of the virtual display arrangement 100 for enabling real life objects (indicated RLO in FIG. 1B) behind the virtual display arrangement 100 to be captured and shown to a user (as a displayed RLO DRLO as indicted by the dotted lines from the RLO, through the camera to the DRLO on the display 110) on the display 110 along with any virtual content to be displayed. The displayed virtual content may be information and/or graphics indicating and/or giving information.

FIG. 1C shows a schematic view of a virtual display arrangement being a viewing device 100 according to an embodiment of the present invention. The viewing device 100 is in some embodiments an optical see-through device, where a user looks in through one end, and sees real-life objects (RLO) in the line of sight (LOS) at the other end of the viewing device 100. In an AR system, these real-life objects may be shown as is or after having been augmented in some manner.

In a VR system, these RLOs may be displayed as virtual versions of themselves or not at all.

In some embodiments the viewing device 100 is a head-mounted viewing device 100 to be worn by a user (not shown explicitly in FIG. 1C) for looking through the viewing device 100. In one such embodiment the viewing device 100 is arranged as glasses, or other eye wear including goggles, to be worn by a user.

The viewing device 100 is in some embodiments arranged to be hand-held, whereby a user can hold up the viewing device 100 to look through it. In some such embodiments, the viewing device 100 is a smartphone or other viewing device s discussed in relation to FIG. 1B which is mounted in a carrying mechanism similar to goggles, enabling the device to be worn as goggles.

The viewing device 100 is in some embodiments arranged to be mounted on for example a tripod, whereby a user can mount the viewing device 100 in a convenient arrangement for looking through it. In one such embodiment, the viewing device 100 may be mounted on a dashboard or in a side-window of a car or other vehicle.

The viewing device comprises a display arrangement 110 for presenting virtual content VC to a viewer, whereby virtual content VC may be displayed to provide a virtual reality or to supplement the real-life view being viewed in line of sight to provide an augmented reality.

As a skilled person would understand, the sensor device 112 comprising a camera of the embodiments of FIG. 1B and FIG. 1C is optional for a VR system, whereas it is mandatory for an AR system.

In the following, simultaneous reference will be made to the virtual object presenting arrangements 100 of FIGS. 1A, 1B and 1C.

The sensor device 112 comprises a sensor for receiving input data from a user.

In some embodiments, the input is provided by the user making hand (including finger) gestures (including movements). In some such embodiments the hand gestures are received through the camera comprised in the sensor device recording the hand gestures that are analyzed by the controller to determine the gestures and how they relate to commands.

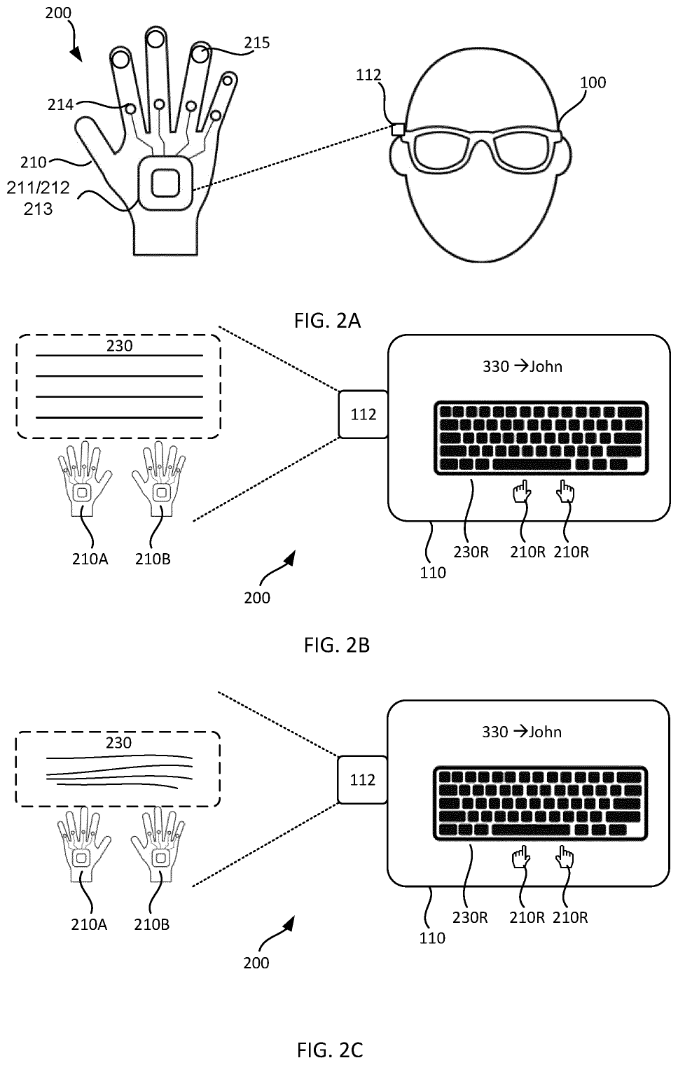

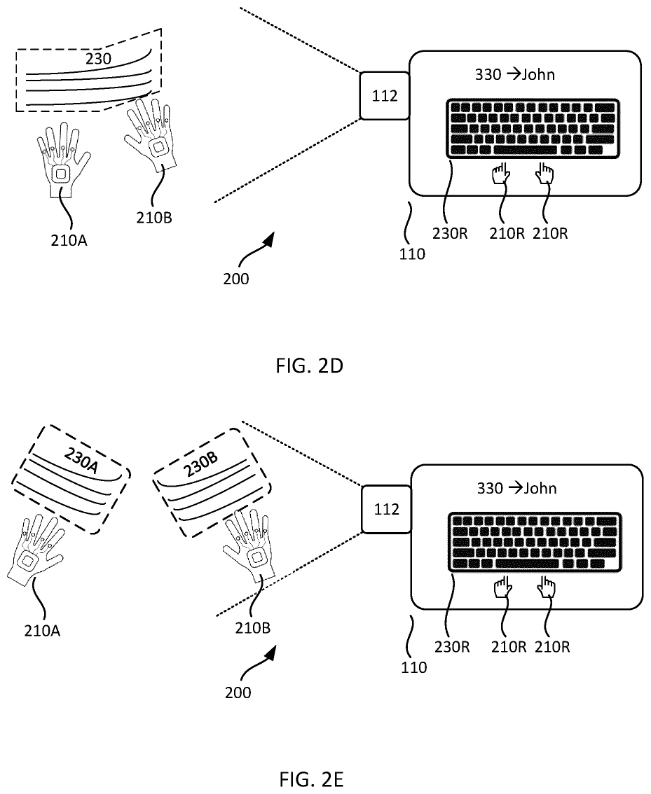

In some such embodiments the hand gestures are received through the sensor device 112 receiving sensor data from an accessory (not shown in either of FIGS. 1A, 1B or 1C, but shown and referenced 210 in FIG. 2) worn by the user, which sensor data indicates the hand gestures and which sensor data are analyzed by the controller to determine the gestures and how they relate to commands. The accessory may be a virtual reality glove. In such embodiments, the accessory 210 may be connected through wireless communication with the sensor device 112, the sensor device 112 thus effectively being comprised in the communication interface 103 or at least functionally connected to the communication interface 103.

FIG. 2A shows a schematic view of a virtual object presenting system 200 according to the teachings herein. The virtual object presenting system 200 comprises one or more virtual object presenting arrangements 100. In this example one virtual object presenting arrangement 100 is shown exemplified by virtual reality goggles or VR eyewear 100 as disclosed in relation to FIG. 1C. In the example of FIG. 2A, a user is wearing the VR eyewear 100.

The system in FIG. 2 also shows a user's hand. In this example the user's hand is arranged with an accessory 210, in this example a VR glove. As noted above, the use of an accessory 210 is optional and the teachings herein may also be applied to the user's hand providing input.

The accessory 210 comprises sensors 214 for sensing movements of the user's hand, such as movement of the whole hand, but also of individual fingers. The sensors may be based on accelerometers for detecting movements, and/or capacitive sensors for detecting bending of fingers. The sensors may alternatively or additionally be pressure sensors for providing indications of how hard a user is pressing against a (any) surface.

The sensors 214 are connected to a chipset which comprises a communication interface 213 for providing sensor data to the viewing device 100. The chipset possibly also comprises a controller 211 and a memory for handling the overall function of the accessory and possibly for providing (pre-)processing of the sensor data before the data is transmitted to the viewing device 100.

In some embodiments the accessory comprises one or more actuators 215 for providing tactile or haptic feedback to the user.

In some embodiments the accessory is a glove comprising visual markers for enabling a more efficient tracking using a camera system of the viewing device. In such embodiments the virtual markers may be seen as the sensors 214.

As a user moves his hands/fingers, the viewing device is thus able to receive indications (such as sensor data or camera recordings) of these movements, analyze these indications and translate the movements into movements and/or commands relating to virtual objects being presented to the user. As a skilled person would understand, there are many different manners of accomplishing this and many variations exist.

FIG. 2B shows a schematic view of a virtual (or augmented) reality as experienced by a user, and how it can be manipulated by using a virtual presentation system 200 as in FIG. 2A. In FIG. 2B only the view that is presented to the user is shown from the viewing device 100, here illustrated by the display 110 of the viewing device 100. In the example of FIG. 2B two hands are shown. In this example both hands are wearing accessories 210, but as noted above the teachings herein may also be applied to optical tracking of hands without the use of accessories such as VR gloves. The hands and their movements, or rather indications of those movements, are picked up by the sensor device 112. As the movements are received, they are analyzed by the controller of the viewing device and correlated to a virtual representation of a keyboard 230R that may or may not be displayed as part of a virtual environment 115 being displayed on the display 110. In some embodiments, virtual representations 210R of the user's hands are also displayed. It should be noted that displaying the virtual representations of the user's hands is optional.

As the user moves his/hers fingers, tapping way at a non-existent keyboard, the movements are interpreted and correlated to the virtual keyboard 230 (that may or may not be displayed) and text (“John”) 235 is provided in the virtual environment 115.

FIG. 2C shows an alternative to the situation in FIG. 2B. As noted above in the summary the inventors have realized that there is a problem in providing an efficient text input in virtual reality in that the user's physical position and movement must be matched to the physical constraints of the physical keyboard. However, the inventors are proposing to do away with such constraints by mapping the virtual input keyboard 230 not to a physical keyboard or to the virtual representation of the keyboard, but to the user's hands (or accessories 210). The inventors are not only proposing to map the location of the virtual keyboard 230 to the location of the hands, but to map the arrangement of the virtual keyboard, i.e. the individual keys of the virtual keyboard 230 to the location and movements of the user's fingers.

Therefore, even though the system may still provide a virtual keyboard 230 that is (almost) linearly mapped (as in FIG. 2B), if the user is careful in the placement of hands and has exact finger movements, the inventors are proposing a manner that enables a non-linear virtual keyboard 230. In FIG. 2B the arrangement of the virtual keys is indicated by the linear or straight lines, whereas in FIG. 2C, the arrangement of the virtual keys is indicated by the non-linear or uneven lines.

By determining the movements of the user's fingers and mapping these movements to the keys of the virtual keyboard 230 based on relative movements instead of absolute movements a non-linear mapping that is much more efficient to use is provided.

In some embodiments the controller 101 is therefore configured to assign a set of keys to each finger (where a set may be zero or more keys) and to assign the virtual location of the keys in such a set based on relative movements of the associated finger. For example, if a set includes 3 keys each key may be assigned a relative movement of 50% of the maximum or average maximum (as measured) movement of that finger, where key 1 is associated with no movement, key 2 is associated with a movement in the range 1-50%, and key 3 is associated with a movement in the range 51-100%. In some embodiments the movement is associated with a direction as well, wherein the direction is also taken to be relative, not absolute.

In some embodiments, the association of relative movement is also not linear, and the associated range may grow with the distance from the center point. For example, if a set includes 4 keys, key 1 is associated with no movement, key 2 is associated with a movement in the range 1-10%, (small movement), key 3 is associated with a movement in the range 11-40% (medium movement) and key 4 is associated with a movement in the range 41-100% (large movement.

In some embodiments, relative is seen as relative the starting point.

In some embodiments, relative is seen as relative to a maximum movement in a direction (possibly as measured).

In some embodiments, relative is seen as relative to a movement. If a movement continues after a feedback for a first key being under the finger has been given, the next key in that direction is selected. The key selection movement is thus relative the continued movement of the finger. The movement in such embodiments thus need not be absolute as regards a distance, but is only counted or measured in number of keys that are given feedback for. In such embodiments, the movement may be considered as being relative the feedback as well.

This allows a user to not necessarily place the hands next to each other, or even in the same plane. The hands may also be oriented differently. This is illustrated in FIGS. 2D and 2E where the hands 210A and 210B are both placed separately and oriented differently. It should be noted that not only does the hands not need to be perfectly aligned, but the fingers do also not need to be (perfectly) aligned. In the example of FIG. 2E, the hands are so far apart that the virtual keyboard 230 may be thought of as two separate keyboards 230A and 230B, one for each hand. This allows and enables a user to for example use the thighs as a writing plane. As the hands/fingers also do not need to be aligned, even with reference to one another, the two planes of writing need not be parallel, which allows and enables a user to even use the sides of the thighs as a writing plane.

In some embodiments the controller is configured to receive initial relative positions for each finger, such as over a default key. This is achieved, in some embodiments, by the viewing device prompting the user to touch a specific key and then monitor the movements executed by the user and associating the location of the key with that movement. As this movement is made by the user relative to a perceived location of the key, the movement is also relative to as per the teachings herein.

In some embodiments, the user is prompted to touch all keys, which provides movement data for each key.

In some embodiments, the user is prompted to touch some keys, which provides movement data for some keys that is then extrapolated to other keys. In some such embodiments the outermost keys are touched. For example, in a QWERTY layout, the user could be prompted to touch ‘Q’, ‘P’, ‘Z’ and ‘M’ (this example disregarding special characters to illustrate a point). In some such embodiments the outermost keys for each finger are touched.

In some embodiments the controller is configured to train by adapting the relative mapping for the keys to the fingers, by noting if a user is indicating an erroneous or unwanted input for a movement (as in deleting an inputted character) and repeating basically the same input again clearly wanting a different (adjacent) character. The next proposed character may be selected based on the adjacency, such as by determining a difference in movement and determining a trend in that difference in a specific direction and then selecting the next character in that direction. The next proposed character may also or alternatively be selected based on semantic analysis of the word/text being inputted. For example if a user is deleting the input character ‘o’ and then repeating basically the same movement, perhaps with a slight tendency towards the left, and if the user has already input “Tra”, the system selects ‘i’ as the next character. The character ‘i’ is both indicated by the slight tend towards the left, and is also most the likely character to follow the already input “Tra” of the characters close to ‘o’.

The controller then updates the relative movement associated with ‘i’ to the movements detected and an adapted training of the keyboard is achieved.

In some embodiments, a re-association of fingers and keys may also be done in a similar manner as adapting based on difference in movements based on the user indicating an error.

Although the description above has been focused on receiving input of movements and/or locations of fingers/hands, the sensors may also provide input on acceleration of a finger, and association an acceleration (in a direction) with a key. This is in some embodiments made in association with the movement in that direction also.

The inventors are thus providing a manner by decoupling the physical plane (real world) with the logical (virtual) plane in order to eliminate the potential accuracy problem of detecting key presses and aligning fingers correctly in (free) air. This enables for a far more ergonomically correct arm and hand positions while enabling very fast typing.

The inventors are also proposing a solution that enables the sensing of the virtual keyboard and keys for better tactile feeling and more accurate pressing of keys, but extends beyond that by also decoupling the exact position of fingers to keys by a virtual magnetism or snapping together with the tactile feeling which leads to less ambiguous keypresses (in between keys) and further supporting even faster typing. This is achieved by use of the actuators 215 in the gloves 215 for providing the feedback of the snapping. The selection of a next key based on snapping is achieved through the selection of a next key based on relative movements.

As will be discussed below, the movement may be relative feedback or a continued movement, wherein if user chooses to continue a movement even after feedback regarding reaching a new key is given, the new next key is selected even if the distance moved is not sufficient.

By making the feedback less noticeable (such as by reducing the amplitude of the feedback) a user can be guided to a proposed next character or key. Similarly by making the decision that the movement is continued faster (for example after a shorter movement or a shorter time), some keys may be skipped and the user is guided to a proposed next character or key. These are two examples of how a snapping key guiding functionality may be provided by the controller.

In some embodiments the controller is configured to detect an upward movement, possibly falling below a threshold indicating a slight movement upwards. This can be used by a user to indicate that the user wishes to be guided to a proposed next character or key, whereby the guiding may be provided as discussed above.

In some embodiments the controller is configured to detect that only a few (one or two, or possibly even three or four) fingers are used for text input.

In some embodiments the controller is configured to detect that a user has a high error rate when typing.

Both these situations indicate an unexperienced user, and the controller is in some embodiments configured to provide the guiding functionality in any manner as discussed in the above for such users, in any or both of those situations. It should be noted that the guiding functionality may be provided regardless of the proficiency and/or experience of the user and ay be a user-selectable (or configurable) option.

In some embodiments the controller is configured to provide the guiding functionality to enable a user to find a next, adjacent key.

In some embodiments the controller is configured to provide the guiding functionality to enable a user to find a next proposed key based on a semantic analysis of the already input text.

In some embodiments the controller is configured to monitor the typing behavior or pattern of a user and adapt the guiding functionality thereafter. In some such embodiments, the controller is configured to guide a finger of a user to keys that represent frequently selected characters for that finger, and as based on a syntactic and/or semantic context. For example, one user might use all 10 fingers in a proper “typewriter” setup, and each finger typically reaches certain keys (with some overlap dependent on what is being written), while another user only uses 4 fingers, and the same key can be touch by two different fingers but also perhaps not by any finger. In such examples, the guiding can be adapted so it is easier to reach (i.e. the controller guides the finger to) the keys typically used by a current finger, and likewise, make it more difficult to reach those less often used (for that specific user).

Furthermore, Guiding can in some embodiments, also be provided on a more coarse level. For example, if the keyboard has a number-keypad far to the right, a distinct and certain movement of the whole hand in that direction might snap onto the keypad. In some such embodiments, the controller is further configured to only change the keyboard in this manner, if this is an action taken by the user previously, or based on a frequency of use. The sensitivity of the guiding can as well be context-sensitive, as discussed herein. For example, if no number is expected, such as in the middle of typing a word, the controller would be less likely to guide to the second keypad (the number pad), thus requiring a more deliberate movement of the hand to actually reach the number keypad in situations where a number is not expected, than in situations where a number is expected.

The same guiding can be applied towards another second input means, such as towards a mouse, a pen or other types of input tools. Depending on the user or context, the controller can snap (or guide) if the hand moves towards that device or if there is a distinct pre-defined gesture.

In some such embodiments the actuators 215 are arranged in the fingertips and utilizes soft actuator-based tactile stimulation based on EAP (Electroactive Polymer). This enables for providing tactile feedback to the user, which enables for allowing the user to (virtually) feel the virtual keys as a finger moves across the keys and the spaces between them.

Through the actuators 215, a soft actuator-based tactile stimulation interface based on multi-layered accumulation of thin electro-active polymer (EAP) films is embedded in each (or some) fingertip part(s) of the glove 210. This enables the glove 210 to generate haptic feedback such as vibration, push towards fingertip, and mimicking a virtual surface generating the feeling of the structure of a surface—e.g. feeling keys as the user touches them in reality. The haptic feedback may be generated by the controller 211 of the glove 210 based on data receive from the viewing device 100, or the haptic data may be provided directly from the viewing device 100. If the user moves a fingertip along a keypad's surface, that keypad (or other structure can be felt by the fingertip by letting the smart material mimicking the structure of the surface at specific positions.

In the following, the fingertips of the glove according to this principle are referred to as smart-tips. To be able to mimic different surfaces and structures, the EAP is built in a matrix where each EAP element can be individually activated by the controller 211 in some embodiments. In some other or additional/supplemental embodiments there are segments defined in the EAP structure that will mimic the different surfaces on a keyboard such as the gap between the keys and protrusions on some keys, such as the protrusions of the keys F, J and 5. In some embodiments there is only two segments, one for feeling of touch and the other segment for indication when a finger is positioned on a key instead of in between two keys.

Some EAP materials can sense pressure and feed that signal back to the system. The system will interpret the pressure signal and determine if it is a press on a button or not. The actuators 215 can thus also act as the sensors 214 as regards pressure sensing. In some embodiments a layer of pressure sensitive material is added on top of or under the EAP material to form pressure sensors 214 to enable sensing of the pressure from the user's fingers. Different pressure sensing technologies can be used that would fit this invention such as capacitive, strain gauge, electromagnetic and piezoelectric among others. Using a standalone pressure sensing material will give the system better dynamic range in the pressure sensing control and support a wider variety of user settings.

The controller 101 of the viewing device is thus configured to cause tactile feedback to be provided to a user through the actuators 215. The controller 101 of the viewing device is also enabled to receive and determine the pressure exerted on a surface through the pressure sensors 214, possibly being part of or comprised in the actuators 215.

As stated above, this is in some embodiments utilized to provide guiding feedback to a user so that the user is enabled to “feel” movements over the keyboards thereby simplifying and aiding the visual perception process of locating a key, even if no or only few visual cues are given. This both allows for a more accurate and faster input as well as removes the need for a displayed representation of the virtual keyboard 230R to be presented in the virtual environment.

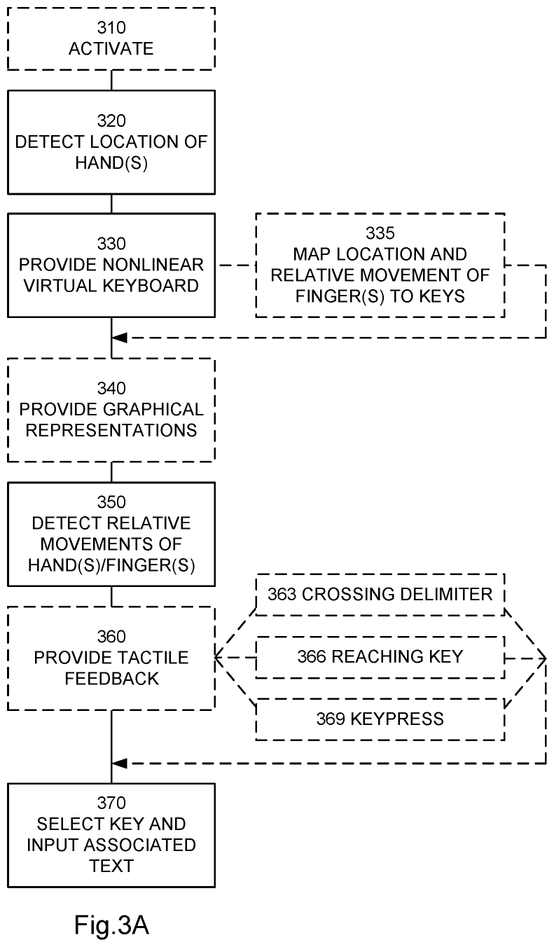

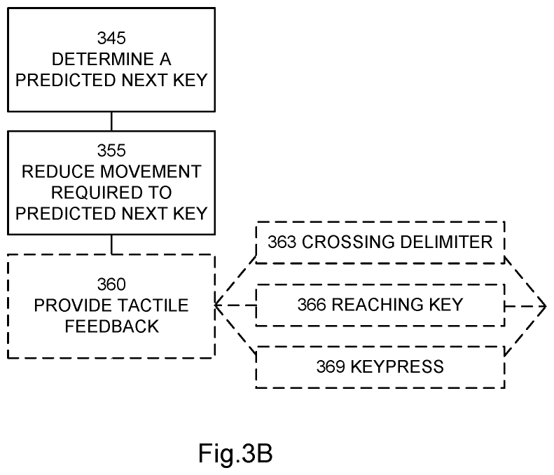

FIG. 3A shows a general flowchart for a method according to the teachings herein. The method corresponds to the operation of the virtual object presenting arrangement 100 as discussed in the above.

Initially a virtual keyboard 230 is to be provided or activated 310. This may be done by a specific application or following a command from the user. The user can command the activation by performing a gesture associated with activating the virtual keyboard, such as holding the palms of the hands in front of the user and bumping them together sidewise (either palm up or down). This gesture can be recognized by the camera 112 of the viewing device 100 but also or alternatively by the sensors 214 of the fingers which all register the same distinct movement (different directions of the hands) and the effect of them bumping together, and which registered movements are analyzed by the controller 101 for determining the gesture and the associated command.

In some embodiments the gesture (or other command) or application may also be associated with a type of keyboard. This enables a user to activate different types of keyboard depending on wanted functions and how rich keyboard environment is wanted. The selection of the keyboard might be explicit from the command (e.g. gesture) or via a combination of gesture and application context. E.g. a specific command might both bring up a browser and a keyboard at the same time.

After the activation the controller determines 320 the location, as including the position and also the orientation of the hands. In some embodiments, the user has some time to put the hand(s) in a suitable position to start typing. This can either be a certain time-duration, e.g. 2 seconds, or until another start-gesture (e.g. double-tapping of the right thumb). In some embodiments, the location is determined as the location of the hands where the user starts moving the fingers in a typing pattern. Such a typing pattern can be that the user is moving the fingers individually. In such embodiments, the controller may be arranged to buffer finger movements to allow for finger movements to not be missed if it takes time to determine the typing pattern.

As the location of the hand(s) is determined, the virtual keyboard 230 is provided 330 in a nonlinear fashion. In some embodiments, the virtual keyboard 230 is provided in a nonlinear fashion by mapping 335 the location and relative movements of the fingers to associated keys. In some embodiments the set of keys associated with each finger may be zero or more keys. In some embodiments one, some or all fingers may be associated with all keys. In some embodiments one, some or all keys may be associated with more than one finger.

In some embodiments all fingers are not indicated to be active. In some such embodiments the user may indicate which fingers are active by gestures. In some such embodiments the user may indicate which fingers are active by presenting them as outstretched as the virtual keyboard is activated. In some other or supplemental such embodiments the user may indicate which fingers are active by moving the active fingers as the virtual keyboard is activated. Assigning active fingers may be done each time the virtual keyboard is activated or at a first initial setup of the virtual keyboard (possibly also in resets of the virtual keyboard). In some such embodiments the user may indicate which fingers are active by giving specific commands.

In some embodiments a default key is mapped to one or more fingers. The default key is the key that is assumed to be at the location of the finger as the virtual keyboard is generated. In some such embodiments, the relative distance is taken form the default key. And in some such alternative or additional embodiments, the one or more fingers associated with a default key are the fingers indicated to be active.

In some embodiments, a virtual representation 230R of the virtual keyboard 230 is displayed 340. To not confuse the user, the representation is displayed as a “normal” linear keyboard regardless the shape of the virtual keyboard 230. I some embodiments virtual representations of the hand(s) is also displayed. They are displayed in relation to the virtual representation 230R of the virtual keyboard and may thus not correspond exactly to the location of the hands in real life, the representation thus also being a non-linear representation of the hands. This enables for a user to act on sense and feel rather than vision, which the inventors have realized is far easier to understand for a user. As discussed in relation to and shown in FIGS. 2D and 2E, which shows an example of the virtual keyboard with virtual hands 210R above the keyboard 230R in a starting-position as seen by the user, the hands 210A, 210B can be in a comfortable position at the side of the user, resting on the arms of a chair, alongside of a user standing up, resting on the thighs of the user or, in fact, in front of the user in a similar pose as being shown in the virtual environment 205. The importance is that the physical position of the hands and arms need not be above a 3D-plane of the representation 230R of the virtual keyboard and need not be exactly as being shown by the representation 210R of the hands.

Movements of the finger(s) are then detected 350. The movements may be detected using the camera 112 (if such is present) and/or through sensor input from the sensors 214 (if such are used)

In embodiments where representations of the hands and/or the virtual keyboard is shown, the relative movement to the starting position of the real hands and fingers is visible to the user in the virtual environment as movements of the virtual hands above the virtual keyboard.

As the user moves the finger(s) a corresponding key is selected 370 by matching a detected relative movement with the associated relative movement, and as a keypress is detected, the character corresponding to the selected key is input. A keypress can be detected in different manners, for example by detecting a downward movement of the fingertip. Other alternatives and more details will be provided in the below.

In some embodiments that are able to provide tactile feedback, such tactile feedback is provided 360 to the user. In some embodiments the tactile feedback provided to the user is tactile feedback in response to a detected keypress in order to inform the user that a keypress has been successfully received/detected. Key-presses are triggered by a down-ward movement of a finger, just as the user typically uses a real keyboard, and if such a distinct movement is registered in embodiments that are capable of providing tactile feedback, there is provided tactile feedback to the user by a vibration, a push or an increase of the pressure on the finger tip from the smart-tip. Hence, the user gets a feedback that the keypress is registered, and if there is no such feedback the user has to press again.

The distinct finger-tapping in this way is a more direct way to trigger an intention to press a key than as in the prior art virtual reality systems that tries to analyze whether the finger crosses a virtual keyboard-plane in 3D. This means that the fingers need not be physically above a common plane, enabling the hand to be put in a more ergonomically correct position as only relative movements of hands and fingers count.

As stated above, a keypress may be detected by detecting a downwards movement of a finger. Alternatively or additionally, a keypress is detected by detecting that the pressure of the finger registered by the pressure sensor 214 is above a threshold level. This enables for a user to tap on a surface (any surface).

In embodiments where downward movement of a finger triggers a keypress, it is a movement relative the hand. If the complete hand moves, this is not interpreted as intended keypresses by the controller to reduce the risk that the movement of a complete hand triggers a large number of unintentional key presses.

The inventors have realized that in addition to providing tactile feedback for informing of a successful keypress, the tactile feedback can be used for much more.

One problem that has been around since the first virtual keyboard was invented and patented by IBM® engineers in 1992 is that a user has problems finding the correct key. The inventors have realized that the actual problem is that a user is neither able to feel the gap between two keys nor the key(s) and thus has difficulties finding the right key, as the user experiences the realized problem(s) when moving a finger to the presumed location of the wanted key.

In order to overcome these problems, the inventors have realized that by utilizing the actuators for providing tactile feedback enables the user to feel the surface of the keyboard with the different keys from the smart-tips. The inventors have further realized that this may be utilized to provide feedback for a key in some embodiments. In some embodiments this feedback is provided when it is determined or otherwise detected that the finger(s) 210 are just above the virtual keyboard 230, or rather above the location of where the keyboard would be (is assumed to be) if it was real. In some embodiments this feedback is provided when it is determined or otherwise detected that the finger(s) 210 are just above the virtual keyboard 230, or rather on or at the location of where the keyboard would be (is assumed to be) if it was real.

The inventors have further realized that this may be utilized to provide feedback for a key in some embodiments. In some such embodiments the feedback is provided in a manner that indicates that a key is under the finger. Examples of such feedback is to increase the pressure through the actuator indicating that the finger rests on a key and/or providing a vibration as a key is reached. The controller 101 is thus configured, in some embodiments, to provide a tactile indicator(s) to indicate that a key has been reached and/or that the finger is currently in a key. In some alternative or supplemental such embodiments the feedback is provided in a manner that identifies the key. Examples of such feedback is to provide feedback representing a marking of the identify of the key. One example is to provide feedback representing a braille character. Just as in (normal) physical keyboards, there is, in some embodiments, virtual “bumps” or ridges on e.g. keys for “5”, “F”, “J” (and/or other keys) modeled via the tactile interface in the smart-tips, for identifying these keys. This simplifies typing while not looking at the keyboard as the user is able to sense or feel one or two anchor points to move relative (as in from which to move the fingers out from). The setting of where to have virtual ridges are is, in some embodiments, adjustable and possible for the user to set freely in a settings menu. The controller 101 is thus configured, in some embodiments, to provide tactile indicators for one or more keys to indicate the identity of the key.

The inventors have also further realized that this may be utilized to provide feedback for a gap, space or distance between keys in some embodiments. Examples of such feedback is to decrease the pressure through the actuator as the finger moves over a distance between two fingers, to decrease the pressure through the actuator as the finger moves outside a finger, to provide a tactile feedback representing the finger moving across an edge as a finger reaches a key, providing a (first) vibration as a distance is traversed or reached and/or providing a (second) vibration as a key is reached. The controller 101 is thus configured, in some embodiments, to provide a tactile indicator(s) for a finger moving between one or more keys and/or for reaching a key.

And, as the inventors have realized, such feedback may be provided to guide the user so that the user is made aware that a wanted or sought for key has been reached.

Hence, in such some embodiments that are able to provide tactile feedback, the user can easily feel whether a finger touches a key, or touches in between multiple keys (in which case a keypress would be ambiguous).

In some embodiments, the tactile feedback is utilized to enable the fingers to sense, via the smart-tips, the keys enabling the user to know that the user has the fingers correctly aligned to keys even if no graphical representations are shown.

Furthermore, the inventors have also realized that based on the tactile feedback provided a further guiding function can be enabled. The further guiding may also be referred to as a snapping function, in that it enables a user's finger to snap to a key (or vice-versa).

To enable such a snapping function, as it is detected that a finger is moving towards another key, that key is drawn to the finger as with magnetism. This is achieved by the controller 101 (simply) reinterpreting the detected movement of the finger and/or the distance associated with the key, thereby reducing the movement required for placing the finger on the key.

In embodiments where tactile feedback is enabled, the user will be able to feel that a new key is reached, as the user is enabled to feel the key (and/or the distance between keys). Alternatively and/or additionally it may also be shown through the graphical representation 230R of the virtual keyboard and/or the graphical representation 210R of the hands. It is not necessary to make the smart-tip feel the full key, as if it was moving on top of the keyboard, but the tactile feedback can be more subtle as a weak indication of gravity that the finger is on a key rather than between (such as by altering the pressure felt by the fingertip; a higher pressure indicates resting on a key). This makes it more distinct to move fingers between keys, also when moving above the keyboard, and enables a faster typing even when not looking at the virtual keyboard.

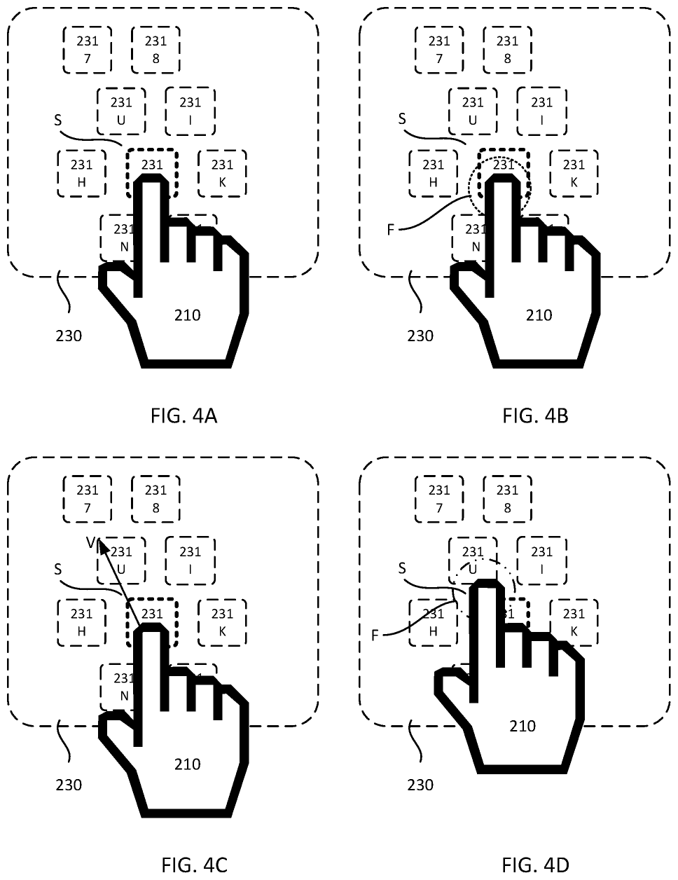

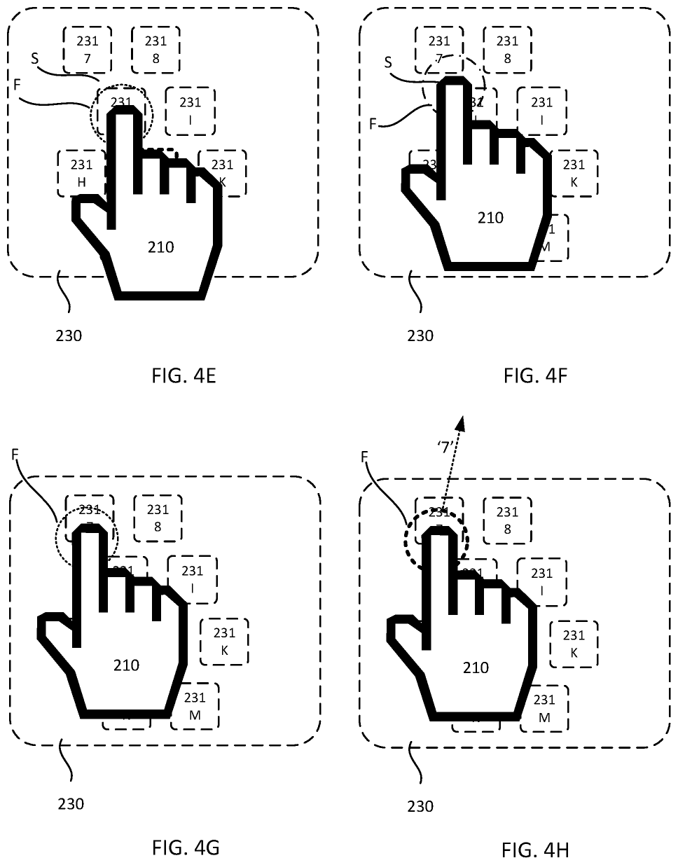

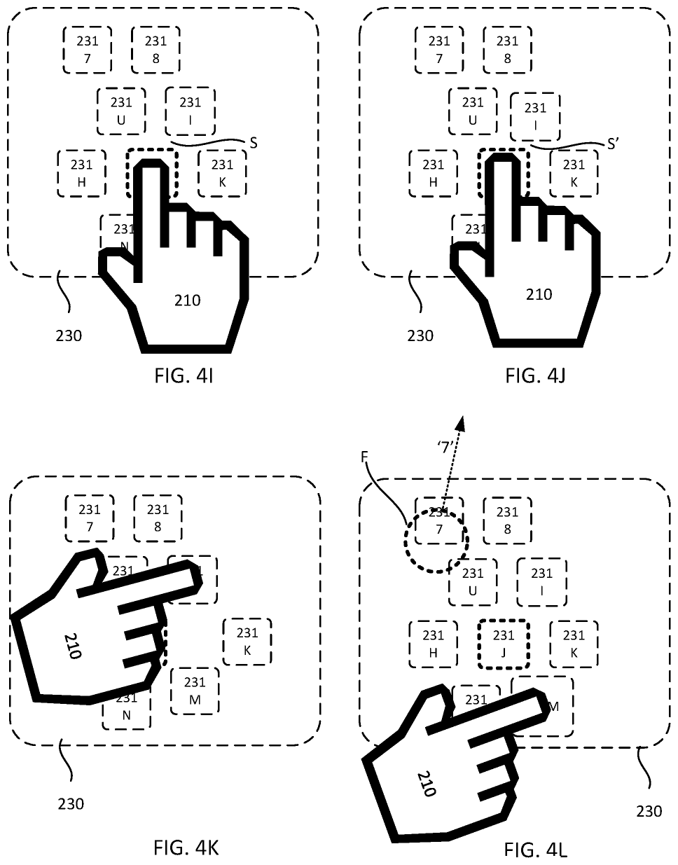

FIG. 4A shows a schematic view of a virtual keyboard 230 having a plurality of virtual keys 231. In this example only 9 keys are shown 231H, 231J, 231K, 231M, 231N, 231U, 231I, 231:7, 231:8, but as a skilled person would understand the teachings herein also apply to several more virtual keys, and virtual keys of a different distribution. In FIG. 4A only one finger is indicated for the user as being active, but it should be noted that the same teachings apply to use of more than one finger as well, and one finger is only shown so as not to clutter the illustration.

As the virtual keyboard is generated, the location of each (active) finger is taken to be over the associated default key 231. In this example the key 231J is the default key for the finger of the hand 210. It should be noted that there is a virtual space or distance S between the keys (only shown for some of the keys to keep the illustration clean, but as a skilled person would understand, the distance may be present between some or all keys. The distance is one example of a delimiter for enabling a user to feel a transition from one virtual key to a next virtual key. Edges is another example of a delimiter as discussed above.

In some embodiments, and as discussed in the above, tactile feedback may be provided to enable the user to perceive that the finger is on top of a key, such as by applying a light pressure through the actuators 215 (not shown in FIG. 4A) to the finger tip. This is shown in FIG. 4B by the dotted circles around the fingertip, the circles being referenced F for feedback and being an example of tactile feedback given to the user to enable the user to perceive the status and thus to understand what actions a movement or gesture will have in a given situation.

As the user moves the hand/finger 210 the movement is detected, by the camera 112 and/or by other sensors 112 receiving input from the sensor devices 214. In this example, and as indicated in FIG. 4C, the movement is towards the virtual key 231U and is indicated by a movement vector V. The movement is received by the controller 101 and is analyzed. The direction of the movement is determined and a next key is determined based on the direction and relative the first key, in this example the start key 231J. The next key 231U may be determined based on the length of the movement, the movement being relative the start point and/or relative the maximum movement of the finger as discussed in the above.

In some embodiments, as the finger 210 (virtually) moves past the space or distance S between the two keys, a tactile feedback F to this effect is given. In some embodiments feedback may be given as soon as the movement starts. In some embodiments the feedback is given as the finger has moved a distance corresponding to a length of a key. In FIG. 4D this is indicated by the circle around the fingertip referenced F. The feedback in this instance would differ from the feedback of FIG. 4B to enable the user to sense or perceive a difference. The feedback of FIG. 4B is thus a first feedback, and the feedback of FIG. 4D is a second feedback. This is also indicated in the figures by the dotted circles being different.

In some embodiments, the next key is selected as the key where the movement stops. This may be determined based on the length of the movement as discussed above. Alternatively, this may be determined relative the feedback. If the movement continues after feedback that a delimiter, such as the space, is crossed, and/or after feedback that a key has been reached, then a further key is selected and feedback is given for that key. This is repeated until the movement stops. It should be noted that the movement may change direction before a next key is selected.

As is sown in FIG. 4E a feedback F may be given as the finger 210 reaches the next virtual key 231U. As is shown in FIGS. 4F and 4G, the user may continue the movement and thereby receiving further feedbacks that a space (or other delimiter) is crossed (FIG. 4F) and/or that a new key is reached (FIG. 4G).

As discussed above, there are several ways a keypress can be detected, and as such is detected, the currently selected virtual key is activated and an associated character is input to the system. In the example of FIG. 4H the virtual key 231:7 associated with the character ‘7’ is selected and a ‘7’ is input. The input is illustrated schematically in FIG. 4H by the dotted arrow and the character ‘7’.

Feedback regarding the keypress may also be given in some embodiments to enable the user to perceive that the keypress was successful. This is indicted by the dashed circle in FIG. 4H. To enable a user to perceive a difference between a keypress, resting on a key and/or passing between two keys, the feedback for a keypress may be different than from the other feedbacks, (i.e. a third feedback), for example being a harder pressure being applied, or by a clicking sensation being provided.

To enable a user to perceive in which direction a delimiter is being crossed and/or a key is being reached, the controller is in some embodiments configured to cause the feedback F to be provided at a corresponding side of the fingertip, thereby emulating a real-life situation. For example if the user moves the fingertip to the left, the feedback will be provided as starting on the left side of the fingertip, possibly sliding or transitioning across the finger tip.

As discussed in relation to FIGS. 4A to 4H, the controller may thus be configured to cause tactile feedback to be provided 360 to the user, through the actuators of the glove 210. The feedback may be provided for reaching or being over 366 a virtual key, crossing a delimiter 363 between two keys and/or for a keypress 369.

Further feedback apart from tactile may also be provided or as an alternative to tactile feedback, for example visible feedback or audible feedback.

Returning to FIG. 4A, it can be noted that the virtual key 231J is marked differently from the other virtual keys (the borders being darker). In some embodiments, tactile feedback may also be given to enable the user to perceive that a specific key is reached or rested over. This may be used to indicate marked keys, such as the ‘F’ and ‘J’ (and ‘5’) keys of a QWERTY-keyboard which are marked with ridges to guide a user to the keys so the user knows that the hands are placed (or aligned) correctly over the keyboard. Alternatively or additionally, this may also be used to identify the character associated with the key to a user, such as by using braille input.

It should be noted that any, some or all embodiments disclosed with regards to the arrangement of non-linear (virtual) keyboard (based on relative movements) may be provided in combination with any, some or all embodiments disclosed with regards to providing tactile feedback.

Likewise, it should also be noted that any, some or all embodiments disclosed with regards to providing tactile feedback may be provided in combination with any, some or all embodiments disclosed with regards to the arrangement of non-linear (virtual) keyboard (based on relative movements).

The aspect of the arrangement of non-linear (virtual) keyboard (based on relative movements) is thus, in some embodiments, a first aspect, whereas the aspect of providing tactile feedback is, in some embodiments, a second aspect. And as noted above, any, some or all embodiments of the first aspect may be combined with any, some or all embodiments of the second aspect.

Returning to the further guiding function, referred to herein as a snapping function, FIG. 4I shows a schematic view of a virtual keyboard 230 as discussed herein, or possibly another type of virtual keyboard. As is illustrated a finger of a user 210 is currently over a first key 213, in this example the key associated with the character ‘J’. To illustrate how the further guiding function is provided, in some embodiments, and examples will be given with reference to FIGS. 4I to 4K.

As a skilled person would realize, there exist a number of variations on how to predict what a user is aiming to input and based on such a prediction proposing a next or further character(s) and thus the key associated with the character. The predicted next character is in some embodiments predicted based on a selected key. The predicted next character is in some embodiments predicted based on a text that has already been input.

In this example it is assumed that the user has just typed “J”. In this example it is further assumed that the user's name is “Jimmy” and/or that the name “Jimmy” is indicated to be typed often. In this example it is thus highly likely that the next key to be selected is the key 231 associated with the character “I”.

As discussed in the above, the snapping function is provided by reducing the movement required for a user to reach the predicted next key. It should be noted that the movement required is, in some embodiments, decreased by decreasing the space between two keys. In FIG. 4J this is shown as that the distance S between the keys for “J” and “I” has been reduced. Alternatively or additionally, the movement required is, in some embodiments, decreased by increasing or scaling up a detected movement of the finger 210. In practice this amounts to the same user experience as regards moving the finger. In these two alternative (or supplemental embodiments) the presented layout of the keys 231 may be adapted to show or indicate the predicted next key(s) by showing the predicted next key at a reduced distance, (as in FIG. 4J).

Alternatively or additionally, the snapping function is provided by increasing the movement required for a user to reach another key than the predicted next key (thereby relatively decreasing the movement required for a user to reach the predicted next key).

In FIG. 4J this is shown as that the distance S between the keys for “J” and “I” has been reduced.

The user will thus be enabled to reach the predicted key in an easier manner than reaching other (not predicted) key(s). In order to further enable the user to realize that the predicted key has been reached, feedback is, in some embodiments, provided as discussed in the above to enable the user to sense crossing the distance and/or reaching the predicted key.

Going on with the example, assuming that the user indeed selects and presses the key 231 associated with “I”, the user has now input “Ji” and the predicted next key would be the key 231 associated with the character “M”. As discussed herein, the movement required to reach the key “M” is to be decreased. In this case, the predicted key is not adjacent the currently selected key however, and the movement required to reach the key is decreased (relatively perhaps) by increasing the movement required to reach the adjacent and/or interposed keys, in this example, the keys 231 associated with “J” and “K”. The movement required to reach the adjacent and/or interposed keys is in some embodiments increased in addition to decreasing the movement required to reach the predicted next key. As stated above, the movement required may be adapted by adapting a distance and/or scaling of a movement.

Figure K shows the situation where “M” is the next predicted key and the interposed keys “J” and “K” have been moved out of the way, thereby making it easier to reach the predicted next key. In this example a combination of both increasing the movement required to reach “J” and “K” by increasing the distance to them and decreasing the movement required to reach “M” by scaling the movement detected and/or by decreasing the distance is used for providing a fast (short) movement through a cleared path.

In some embodiments the next predicted key may be the same key as the user is presently resting a finger over. In such a case, the movement required is already none, but may still be reduced relative other keys, by increasing the movement required to reach the other keys. In some embodiments, the movement required to reach other keys is, in some such embodiments, increased by increasing the movement required to leave the presently selected key. In one alternative, the size of the key is increased. In some such embodiments, the size is increased in all directions. In some alternative such embodiments, the size is increased in the direction of unpredicted key(s). In one alternative, that may be additional, the detected movement is scaled so that a larger movement is required to leave the key. In some such embodiments, the movement is scaled in all directions. In some alternative such embodiments, the movement is scaled in the direction of unpredicted key(s).

In both such alternatives the user is thus required to move a finger further to leave the selected key and/or to reach the unpredicted key(s). It should be noted that the size of the selected key may be changed, the size of the predicted key may be changed, and/or both.

FIG. 4L illustrates the situation where “M” is both the currently selected key and the predicted next key, where the movement required to reach the predicted key is decreased by enlarging the size of the predicted (and selected) key.

It should be noted that even though the description above for how to decrease a distance is focused on changing the distance, by changing the actual distance (by moving keys), such as in FIG. 4J, the distance (and thus the movement required) may also be adapted by adapting the size of the key, similarly as in the example of FIG. 4L.

In this regard FIG. 3B shows a flowchart for a general method of providing a further guiding (snapping function) and/or for providing tactile input. As a virtual keyboard is utilized, possibly as is discussed in relation to FIG. 3A, a predicted next key is predicted 345. As indicated by the numbering this may be done in relation to providing the graphical representations, 340 as the graphical representations may be adapted based on the predicted next key as discussed in relation to any, some or all of FIGS. 4I-4L. The movement required to reach the predicted next key(s) is reduced 355, as discussed in the above, for example as discussed in relation to any, some or all of FIGS. 4I-4L.

The further guiding is, in some embodiments, supplemented by providing tactile feedback 360, enabling a user to sense that the predicted next key is reached, possibly sooner or faster than (otherwise) expected.

It should be noted that even if the disclosure herein is sometimes aimed at the movement of a hand, it is equally applicable to the movement of a finger in any, some or all embodiments. Similarly the teachings herein are also applicable to the movement of a part of the hand, and/or one or more fingers. The teachings herein are thus applicable to the movement of at least a portion of a hand. In some embodiments, the movement that is relevant is determined by the design of the glove being used.

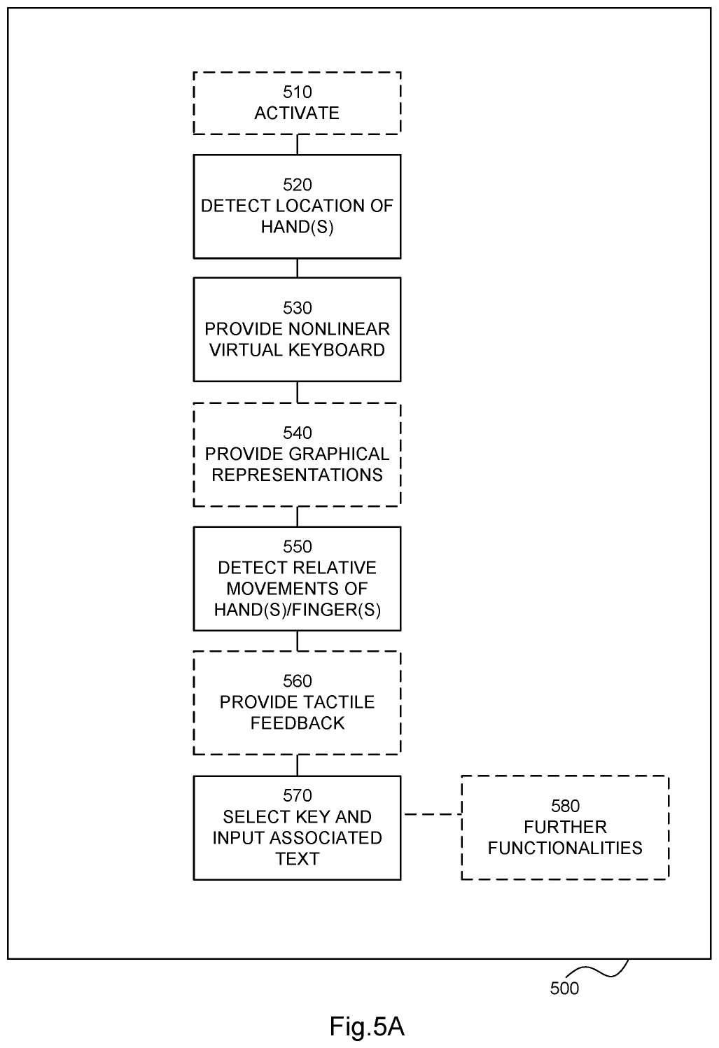

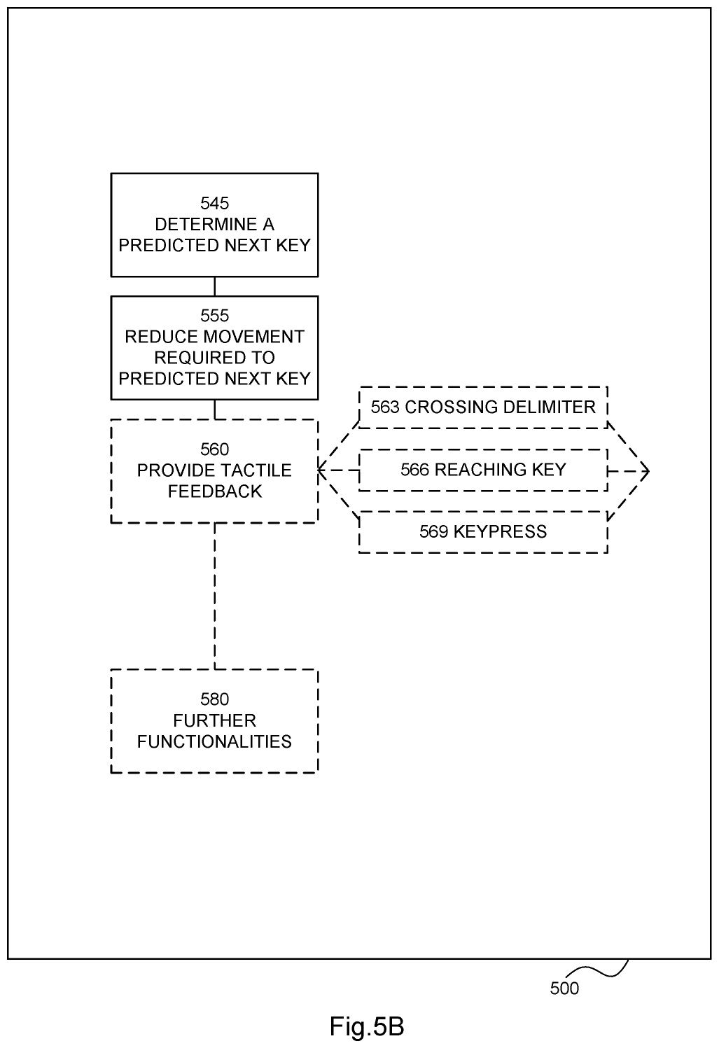

FIG. 5A shows a component view for a software component or module arrangement 500 according to an embodiment of the teachings herein. The software component arrangement 500 is adapted to be used in a virtual object presenting arrangement 100 as taught herein for providing text input in a virtual object presenting arrangement 100 comprising an image presenting device 110 arranged to display a virtual environment, wherein the software component arrangement 500 comprises a software component 520 for detecting a location of a hand 210; a software component 530 for providing a virtual keyboard 230 at the location of the hand 210, the virtual keyboard 230 being nonlinearly mapped to the hand 210; a software component 550 for detecting a relative movement of the hand 210; a software component 570 for selecting a virtual key 231 based on the relative movement; and a software component for inputting a text character associated with the selected key in the virtual environment 205. For the context of the teachings herein a software component may be replaced or supplemented by a software module. As is indicated in FIG. 5A, the arrangement may further comprise modules 510, 540, 560 for any, some or all of the method steps discussed in relation to FIG. 3A. As is also indicated by FIG. 5A, the arrangement may comprise further software modules 580 for further functionalities implementing any method as disclosed herein.

FIG. 5B shows a component view for a software component or module arrangement 500 according to an embodiment of the teachings herein. The software component arrangement 500 is adapted to be used in a virtual object presenting arrangement 100 as taught herein for providing text input in a virtual object presenting arrangement 100 comprising an image presenting device 110 arranged to display a display a virtual keyboard 230 comprising one or more virtual keys 231, wherein the one or more keys 231 are arranged so that a movement is required to move from one key 231 to a next key 231. The software component arrangement 500 comprises a software component 545 for determining a predicted next key 231 in the virtual keyboard 230 and a software component 555 for reducing the movement required to move to the predicted next key 231.

For the context of the teachings herein a software component may be replaced or supplemented by a software module.

As is indicated in FIG. 5B, the arrangement may further comprise modules 560, 563, 566, 569 for any, some or all of the method steps discussed in relation to FIG. 3B. As is also indicated by FIG. 5B, the arrangement may comprise further software modules 580 for further functionalities implementing any method as disclosed herein.

As discussed in regards to the two aspects herein, the arrangement 500 of FIG. 5A may in some embodiments be the same as or incorporating the arrangement 500 of FIG. 5B.

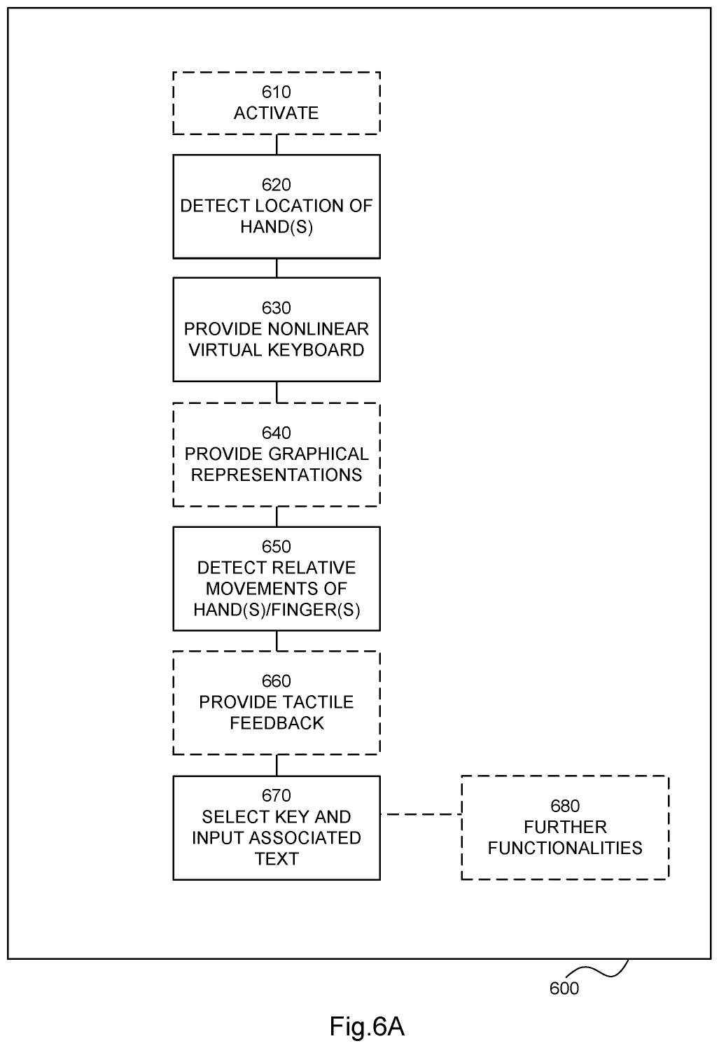

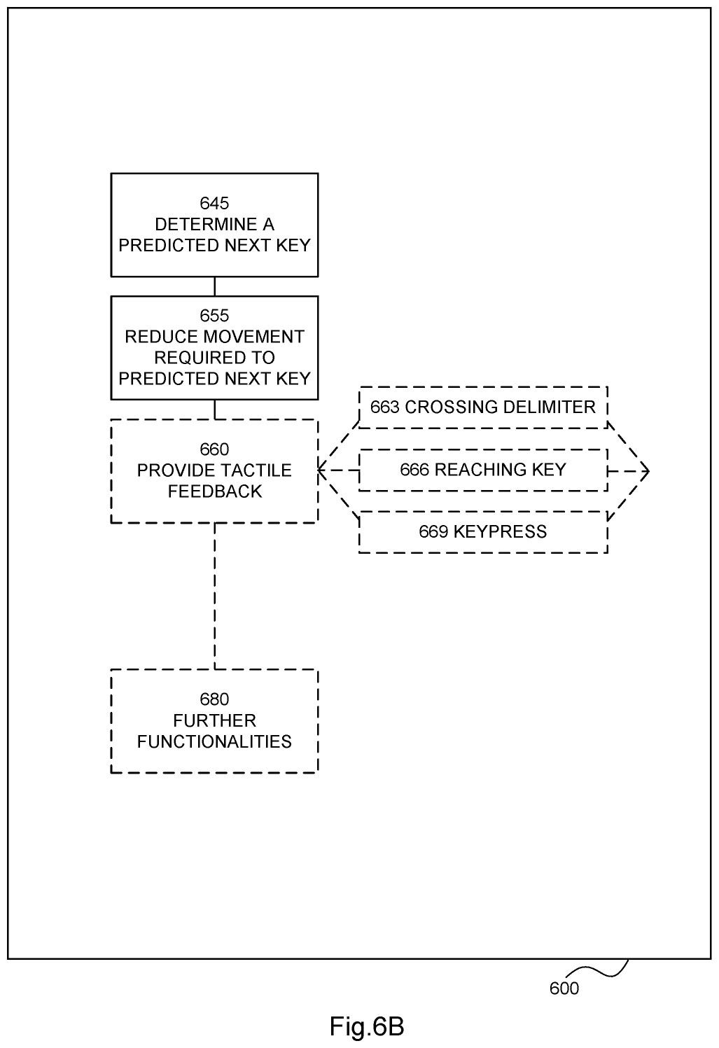

FIG. 6A shows a component view for an arrangement 600 according to an embodiment of the teachings herein. The virtual object presenting arrangement 600 of FIG. 6A comprises an image presenting device 110 arranged to display a virtual environment and for providing text input in said virtual environment. The virtual object presenting arrangement comprising: circuitry 620 for detecting a location of a hand 210; circuitry 630 for providing a virtual keyboard 230 at the location of the hand 210, the virtual keyboard 230 being nonlinearly mapped to the hand 210; circuitry 650 for detecting a relative movement of the hand 210; circuitry 670 for selecting a virtual key 231 based on the relative movement; and circuitry for inputting a text character associated with the selected key in the virtual environment 205.

As is indicated in FIG. 6A, the arrangement may further comprise circuits 610, 640, 660 for any, some or all of the method steps discussed in relation to FIG. 3A. As is also indicated by FIG. 6A, the arrangement may comprise further circuitry 680 for further functionalities for implementing any method as disclosed herein.

FIG. 6B shows a component view for an arrangement 600 according to an embodiment of the teachings herein. The virtual object presenting arrangement 600 of FIG. 6B comprises an image presenting device 110 arranged to display virtual keyboard 230 comprising one or more virtual keys 231, wherein the one or more keys 231 are arranged so that a movement is required to move from one key 231 to a next key 231, the virtual object presenting arrangement 600 comprising circuitry 645 for determining a predicted next key 231 in the virtual keyboard 230 and circuitry 655 for reducing the movement required to move to the predicted next key 231.

As is indicated in FIG. 6B, the arrangement may further comprise circuits 660, 663, 666, 669 for any, some or all of the method steps discussed in relation to FIG. 3B. As is also indicated by FIG. 6B, the arrangement may comprise further circuitry 680 for further functionalities implementing any method as disclosed herein.

As discussed in regards to the two aspects herein, the arrangement 600 of FIG. 6A may in some embodiments be the same as or incorporating the arrangement 600 of FIG. 6B.

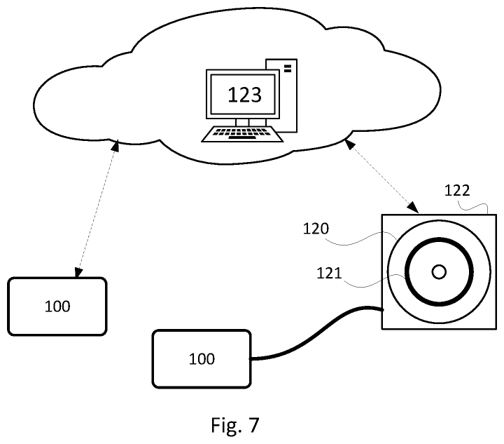

FIG. 7 shows a schematic view of a computer-readable medium 120 carrying computer instructions 121 that when loaded into and executed by a controller of a virtual object presenting arrangement 100 enables the virtual object presenting arrangement 100 to implement the teachings herein.

The computer-readable medium 120 may be tangible such as a hard drive or a flash memory, for example a USB memory stick or a cloud server. Alternatively, the computer-readable medium 120 may be intangible such as a signal carrying the computer instructions enabling the computer instructions to be downloaded through a network connection, such as an internet connection.

In the example of FIG. 7, a computer-readable medium 120 is shown as being a computer disc 120 carrying computer-readable computer instructions 121, being inserted in a computer disc reader 122. The computer disc reader 122 may be part of a cloud server 123—or other server—or the computer disc reader may be connected to a cloud server 123—or other server. The cloud server 123 may be part of the internet or at least connected to the internet. The cloud server 123 may alternatively be connected through a proprietary or dedicated connection. In one example embodiment, the computer instructions are stored at a remote server 123 and be downloaded to the memory 102 of the virtual object presenting arrangement 100 for being executed by the controller 101.

The computer disc reader 122 may also or alternatively be connected to (or possibly inserted into) a virtual object presenting arrangement 100 for transferring the computer-readable computer instructions 121 to a controller of the virtual object presenting arrangement 100 (presumably via a memory of the virtual object presenting arrangement 100).

FIG. 7 shows both the situation when a virtual object presenting arrangement 100 receives the computer-readable computer instructions 121 via a server connection and the situation when another virtual object presenting arrangement 100 receives the computer-readable computer instructions 121 through a wired interface. This enables for computer-readable computer instructions 121 being downloaded into a virtual object presenting arrangement 100 thereby enabling the virtual object presenting arrangement 100 to operate according to and implement the invention as disclosed herein.

1-37. (canceled)

38. A method for providing text input in a apparatus comprising an image presenting device arranged to display a virtual keyboard comprising one or more virtual keys, wherein the one or more keys are arranged so that a movement over a distance for a finger is required to move from one key to a next key, the method comprising
determining a predicted next key in the virtual keyboard and
reducing the distance required to move to the predicted next key.

39. The method of claim 38, wherein the method further comprises providing tactile feedback indicating that the predicted next key is reached.

40. A method for providing text input in a virtual object presenting apparatus comprising an image presenting device configured to display a virtual environment, the method comprising:
detecting a location of a hand;
providing a virtual keyboard at the location of the hand, the virtual keyboard being nonlinearly mapped to the hand;
detecting a relative movement of at least a portion of the hand;
selecting a virtual key based on the relative movement; and
inputting a text character associated with the selected key in the virtual environment.

41. An apparatus configured to provide for text input, the apparatus comprising a display arranged to display a virtual keyboard comprising one or more virtual keys, wherein the one or more keys are arranged so that a movement over a distance for a finger is required to move from one key to a next key, the apparatus further comprising controller circuitry configured to determine a predicted next key in the virtual keyboard and to reduce the distance required to move to the predicted next key.

42. The apparatus of claim 41, wherein the controller circuitry is further configured to receive a selection of a present key and to determine the predicted next key based on the present key.

43. The apparatus of claim 41, wherein the controller circuitry is further configured to receive an input of text and to determine the predicted next key based on the input text.

44. The apparatus of claim 41, wherein the controller circuitry is further configured to reduce the distance of the movement required to move to the predicted next key by
receiving a movement of a user and to scale up the movement of the user in the direction of the predicted next key thereby reducing the distance required to move to the predicted next key.

45. The apparatus of claim 41, wherein the controller circuitry is further configured to reduce the distance of the movement required to move to the predicted next key by increasing a size of the predicted key thereby reducing the distance required to move to the predicted next key.

46. The apparatus of claim 41, wherein the controller circuitry is further configured to receive a selection of a present key and is still further configured to reduce the distance of the movement required to move to the predicted next key by increasing a size of the selected key thereby reducing the distance required to move to the predicted next key.

47. The apparatus of claim 46, wherein the controller circuitry is further configured to increase the size of the selected key in the direction of the predicted next key.

48. The apparatus of claim 41, wherein the controller circuitry is further configured to provide tactile feedback (F) when being on a virtual key.

49. A system comprising the apparatus of claim 41 and an accessory device, the accessory device comprising one or more actuators, wherein the controller circuitry of the apparatus is configured to provide feedback through the one or more actuator, wherein the accessory device is a glove and at least one of the one or more actuators is arranged at a fingertip of the glove.

50. A apparatus comprising a display arranged to display a virtual environment and controller circuitry configured to:
detect a location of a hand;
provide a virtual keyboard at the location of the hand, the virtual keyboard being nonlinearly mapped to the hand;
detect a relative movement of at least a portion of the hand;
select a virtual key based on the relative movement; and
input a text character associated with the selected key in the virtual environment.

51. The apparatus of claim 50, wherein the controller circuitry is further configured to detect the location of the hand by detecting a location of at least one finger and nonlinearly map the virtual keyboard to the hand by associating a set of virtual keys to each of the at least one finger.

52. The apparatus of claim 51, wherein the controller circuitry is further configured to nonlinearly map the virtual keyboard to the hand by aligning the virtual position of one virtual key in the associated set of virtual keys with the location of the associated finger.

53. The apparatus of claim 50, wherein the relative movement is relative to at least one of:
a start position;
a maximum movement;
a continued movement; and
a feedback.

54. The apparatus of claim 50, wherein the controller circuitry is further configured to provide tactile feedback when crossing a delimiter.

55. The apparatus of claim 50, wherein the controller circuitry is further configured to provide tactile feedback when being on a virtual key.

56. The apparatus of claim 50, wherein the apparatus further comprises a camera and wherein the controller circuitry of the apparatus is configured to determine the location and to determine relative movement of the hand by receiving image data from the camera.

57. A virtual object presenting system comprising the apparatus of claim 51 and an accessory device, the apparatus further comprising a sensor device and the accessory device comprising at least one sensor, wherein the controller circuitry of the apparatus is configured to determine the location and to determine the relative movement of the hand by receiving sensor data from the at least one sensor of the accessory device through the sensor device.

58. The virtual object presenting system of claim 57, wherein the accessory device further comprising one or more actuators for providing tactile feedback, and wherein the controller circuitry of the apparatus is configured to provide said tactile feedback through the at least one of the one or more actuators, and wherein the accessory device is a glove.
